(19) United States
(12) Patent Application Publication
(10) Pub. No.: US 2005/0110197 A1
(43) Pub. Date: May 26, 2005

(54) Concrete pole cast molding system and method

(76) Inventor: Guy Deffense, Jacksonville, FL (US)

Correspondence Address: Thomas C. Saitta;Rogers Towers, P.A., Suite 1500, 1301 Riverplace Boulevard, Jacksonville, FL, 32207, US

(21) Appl. No.: 10/718,312

(22) Filed: Nov. 20, 2003

(51) Int. Cl. B29C 39/04; B29C 39/10

(52) U.S. Cl. 264/333; 425/117; 249/83; 425/439; 249/97; 249/137

(57) ABSTRACT

A method and apparatus for casting an elongated pole member. In accordance with one embodiment, the method includes providing an elongated casting mold having a lengthwise rim boundary defining a planar open mouth from which a cast pole member, while still in a substantially plasticized state, can be slidably removed without damaging the mold or comprising the cast member. The elongated casting mold is positioned in a horizontal molding orientation where concrete casting material is poured into the casting mold and the mold is vibration treated to remove air pockets. After withdrawing rebar constraint pins, a final vibration cycle fills the air pockets left thereby. The mold is then rotated approximately 180° about its lengthwise axis to a horizontal demolding orientation in which the lengthwise open rim boundary of the mold is facing downward and the cast member can be slidably removed therefrom with the flat backside of the U-shaped cast member supported upwardly by the receiving surface. The receiving surface supporting the flat backside cast member surface is then lowered while the mold is held substantially stationary such that the cast member is gravity released from the mold.

### BACKGROUND OF THE INVENTION

1. Technical Field

The present invention relates generally to structural support members, and in particular, to molded concrete structures and methods for producing the same. More particularly, the present invention relates to a method and system for casting a concrete pole that leverage contour characteristics of a casting mold to facilitate an efficient production cycle.

2. Description of the Related Art

Vertical support structures, such as utility poles for telephone and power lines, are made from various materials having requisite strength and durability to safely function in a variety of environments. Wood and metal are among the most common material compositions used for utility pole construction, each having drawbacks and disadvantages. For example, poles made of metal are often subject to rust and corrosion, and are electrically conductive and therefore incompatible with applications requiring electrical insulating properties. In addition, the materials and manufacturing expenses of metallic poles makes them a less practical option for the vast quantities required for geographically widespread utility pole applications.

Traditionally, utility poles been manufactured predominantly of wood, which is relatively abundant, inexpensive, nonconductive. However, wood poles exhibit internal structural asymmetries and inconsistent material properties in the form of knots, checks, shakes and splits that tend to negatively impact strength and load bearing properties of the poles. Furthermore, wood poles are susceptible to damage from rot and decay as well as from attack by a host of insects, birds and microbiological agents, resulting in a reduced design life and necessitating a design setoff to compensate for the temporal shift in strength over the pole's service life. Maintenance is required in combating the foregoing environmental hazards to which wood poles are susceptible such as by coating and injecting the wooden structural members with a preservative, such as creosote. Furthermore, the toxic properties of such substances result in greater regulation and associated costs.

In view of the many problems and inefficiencies relating to wood and metal, concrete poles have come into widespread use for many utility pole applications such as for power transmission and distribution, roadway and other highmast lighting, traffic signals, communications antennas, etc. Concrete poles are highly durable and are substantially maintenance free. Unlike other pole construction materials, concrete suffers no loss of strength over the years, being resistant to termites, woodpeckers, fire, rot and corrosion. Its durability in soil permits the economy of direct burial without the use of contaminating chemical treatments. The precision engineering of concrete pole casting ensures the poles have minimum strengths and other load-bearing characteristics thus minimizing the uncertainty of vertical support design plans and enabling the poles to remain unguyed thereby saving space and eliminating clutter. In addition, concrete poles provide a more progressive aesthetic appearance in metro areas and, constituting an inert material, can be recycled or accepted as clean fill at the end of their service life.

Concrete poles are manufactured in a wide range of shapes, strengths and sizes, to address many different applications and are tapered for balance and reinforced, typically with metallic reinforcing bar, or rebar, to provide adequate strength and deflection characteristics. Two fundamental approaches are used for casting concrete poles. Traditionally, concrete poles have been cast using the traditional, so-called wet cast technique in which the concrete is poured into a basin-like mold where it cures and sets as reinforced by rebar which is pre-positioned in the mold. The most common mold forms used for the wet cast type poles typically have either a square cross-section or a T-shape based cross-section used for forming H-beam contoured poles. In either case, the geometry of the mold cast requires that the poured concrete remain in the mold until the concrete has set. The other basic approach, which has come into widespread use, is to form the concrete pole as a hollow cylindrical structure by using a substantially cylindrical cage of rebar and depositing concrete by centrifugal casting inside and outside the rebar cage.

While concrete enjoys the aforementioned advantages and benefits over other pole construction materials, the foregoing molding processes for concrete poles are time consuming and costly. Specifically, and as mentioned above, the conventional processes by which concrete poles are cast require that a cast pole remain enclosed within its mold until the pole has substantially set at which time the mold can be removed from the hardened pole. The time for adequate curing of the concrete is typically from one to several days, resulting in the casting process being limited by the number of available molds. As each mold is a very large and expensive piece of equipment, this need for multiple casts imposes substantial additional cost and delay to the production cycle.

It can therefore be appreciated that a need exists for an improved concrete pole and method and system for producing the same that reduces or eliminates the foregoing production cycle costs and delays. The present invention addresses such a need.

### SUMMARY OF THE INVENTION

A method and apparatus for casting an elongated pole member are disclosed herein. In accordance with one embodiment, the method includes providing an elongated casting mold having a lengthwise rim boundary defining a planar open mouth from which a cast pole member, while still in a substantially plasticized state, can be slidably removed without damaging the mold or comprising the cast member. The elongated casting mold is positioned in a horizontal molding orientation where concrete casting material is poured into the casting mold and the mold is vibration treated to remove air pockets. After withdrawing rebar constraint pins, a final vibration cycle fills the air pockets left thereby. The mold is then rotated approximately 180° about its lengthwise axis to a horizontal demolding orientation in which the lengthwise open rim boundary of the mold is facing downward and the cast member can be slidably removed therefrom with the flat backside of the U-shaped cast member supported upwardly by the receiving surface. The receiving surface supporting the flat backside cast member surface is then lowered while the mold is held substantially stationary such that the cast member is gravity released from the mold.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1A depicts a concrete pole casting apparatus in accordance with a preferred embodiment of the present invention;

FIG. 1B illustrates an overhead view of the concrete pole casting apparatus shown in FIG. 1A;

FIG. 2A depicts a perspective view of a U-channel casting mold in accordance with the present invention;

FIG. 2B illustrates a cross-section view of a U-channel casting mold in accordance with the present invention;

FIG. 3 depicts a cross-section view of a transition shoulder section of a casting mold in accordance with the present invention;

FIG. 4A illustrates a front view of a cast member in accordance with the present invention;

FIG. 4B depicts a cross-section view of the cast member shown in FIG. 4A; and

FIG. 5 is a flow diagram illustrating process steps performed during casting of an elongated concrete pole in accordance with the present invention.

### DETAILED DESCRIPTION OF A PREFERRED EMBODIMENT

The present invention is described in a preferred embodiment in the following description with reference to the figures. While this invention is described in terms of the best mode for achieving this invention's objectives, it will be appreciated by those skilled in the art that variations may be accomplished in view of these teachings without deviating from the spirit or scope of the present invention.

The present invention is directed to an improved method and apparatus for casting elongated concrete pole members such as are used to support power lines, street lights, etc. A specialized casting mold is designed to enable the typically very large (typically 3 to over 50 meters) cast members to be gravity released onto a receiving platform while in a substantially plasticized state prior to curing, thereby freeing the casting mold to be used for subsequent molding cycles while the released cast members cure and harden. To this end, the casting mold of the present invention has an inner mold liner contour shaped to produce an elongated U-channel shaped cast member having a substantially flat backside forming a base from which two lateral side walls and one or more crosswise supporting transition shoulders extend outwardly. To facilitate release of the cast member before curing, all surface edges extending outwardly from the flat backside preferably taper from wider to narrower. Floating reinforcing bar (rebar) is deployed lengthwise within the mold as loosely restrained by horizontal and vertical rebar retention pins before the concrete is poured to provide the requisite strength and load-bearing characteristics. As explained in further detail with reference to the figures, the present invention employs molding/demolding processing steps that leverage the structural characteristics of the casting mold to facilitate a rapid and substantially continuous casting cycle and production process for concrete poles.

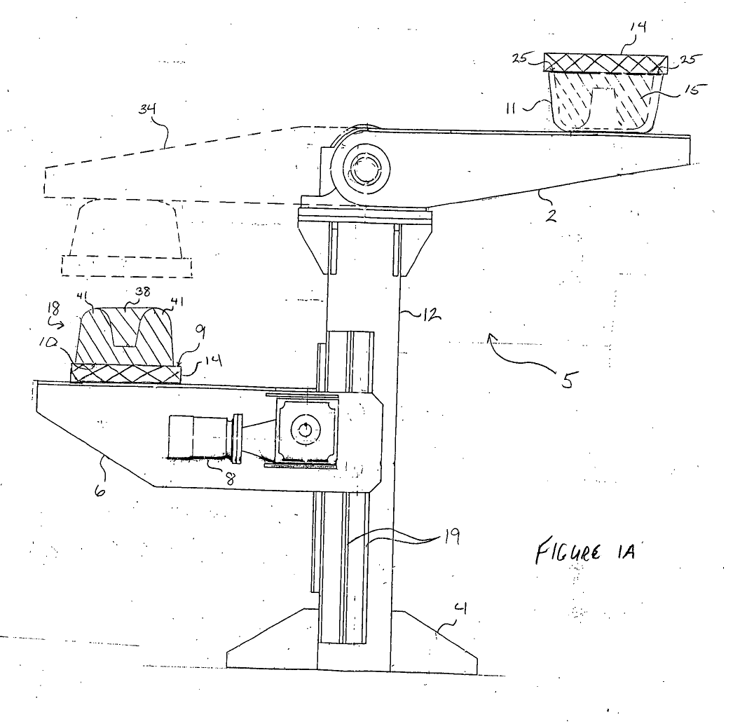

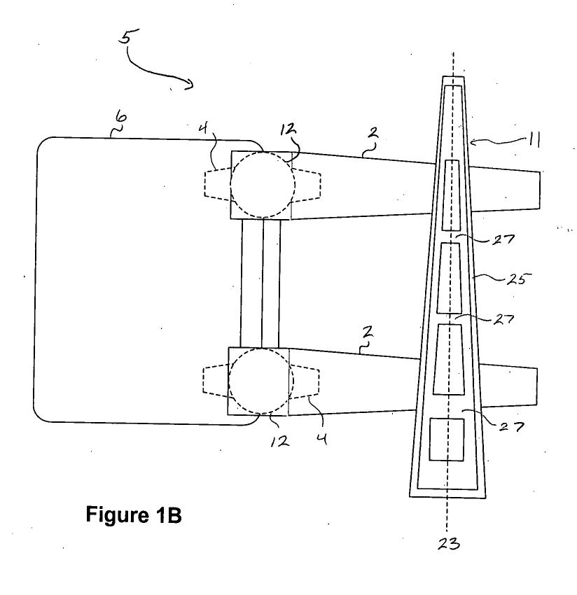

With reference now to the figures, wherein like reference numerals refer to like and corresponding parts throughout, and in particular with reference to FIGS. 1A and 1B, there are depicted alternate views of a concrete pole casting apparatus in accordance with a preferred embodiment of the present invention. Specifically, a concrete pole casting apparatus 5 generally comprises a mold support member in the form of one or more pivoting armatures 2 that are hinged and supported on vertical supports 12 and corresponding base members 4. Pivoting armatures 2 are preferably lever-like members rotatably driven by a motor or other driving mechanism (not depicted) and utilized to support and rotatably adjust the orientation of a casting mold 11 during a given molding/demolding cycle in the manner specified herein.

Concrete pole casting apparatus 5 further includes a receiving platform 6 that is vertically adjustable, such as driven by a motor 8 or other mechanical or electromechanical driving means, along drive tracks 19 on vertical supports 12. As explained in further detail below in reference to the cast molding method of the present invention, the vertical position of receiving platform 6 is advantageously adjusted during a molding/demolding cycle to facilitate a more efficient demolding process with a reduced risk of damaging the cast member when the cast member is released in a substantially plasticized state.

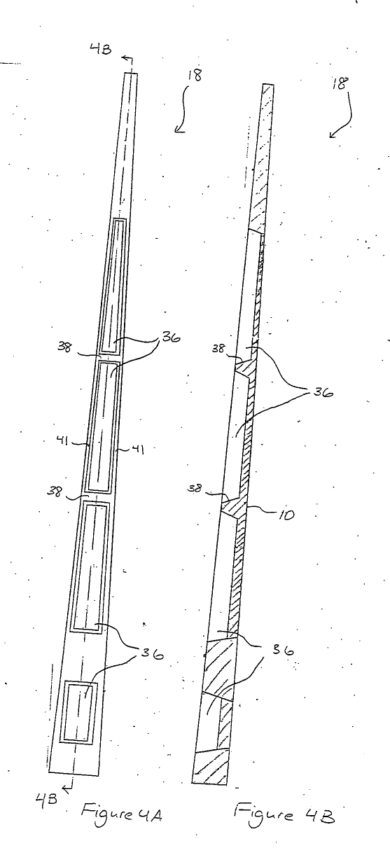

Casting mold 11 is an elongated, typically metallic member that is itself a molded or extruded piece having a molding contour for forming a cast member having the desired characteristics. As shown in FIGS. 1A and 1B, casting mold 11 is fixedly attached in a horizontal disposition on one side across one or more of pivoting armatures 2. Welding or a variety of removable mechanical fasteners such as clamps, bolts, etc., may be utilized to fixedly attach casting mold 11 to armatures 2 in the manner shown. The casting shape rendered by casting mold 11 is determined by the inner contour of the substantially rigid, lengthwise open vessel liner bounded at its upper edge by an open rim boundary 25 defining a lengthwise planar boundary forming the flat back of the pole members cast within mold 11 such as the U-channel contoured casting member 18 shown in the depicted embodiment and in FIGS. 4A and 4B. The material constituting casting mold 11 is preferably a metallic alloy such as stainless steel or a sufficiently strong ceramic material.

In its role as a mold for relatively long vertical support members requiring a low center of gravity when vertically erected, and as shown in the depicted embodiment, the lengthwise contour of casting mold 11 is generally trapezoidal with the lateral edges of the mold liner narrowing in a smoothly tapering manner from one end to the other along lengthwise axis 23. The overhead view shown in FIG. 1B reveals the inner liner contouring of casting mold 11 through the open mouth defined by the lengthwise open rim boundary 25 which defines the upper mold boundary for concrete casting material 15 when the cast is poured in the horizontally supported molding orientation, and from which a cast member 18 is subsequently slidably removed after rotating casting mold 11 to the horizontal demolding position 34 as shown in FIG. 1A. As utilized herein, “casting material” refers to an uncured water admixed material such as a concrete, sand and water slurry mixture that is utilized for casting concrete pole members. In a preferred embodiment, casting material 15 is preferably low water content concrete slurry mixture having relatively low fluidity characteristics.

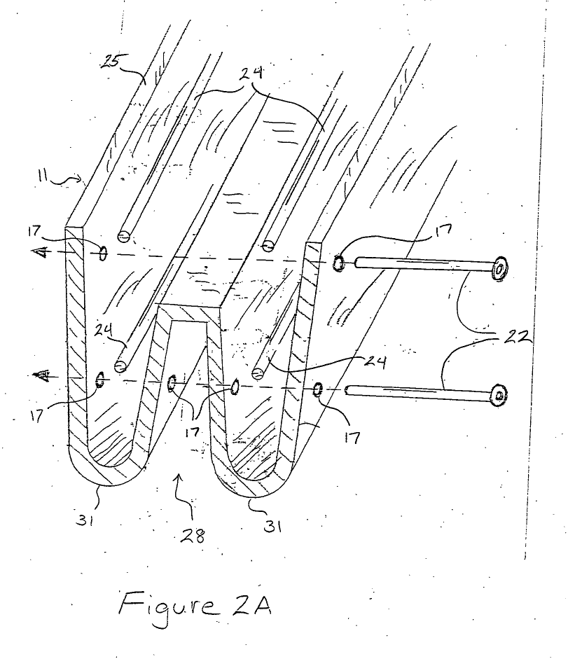

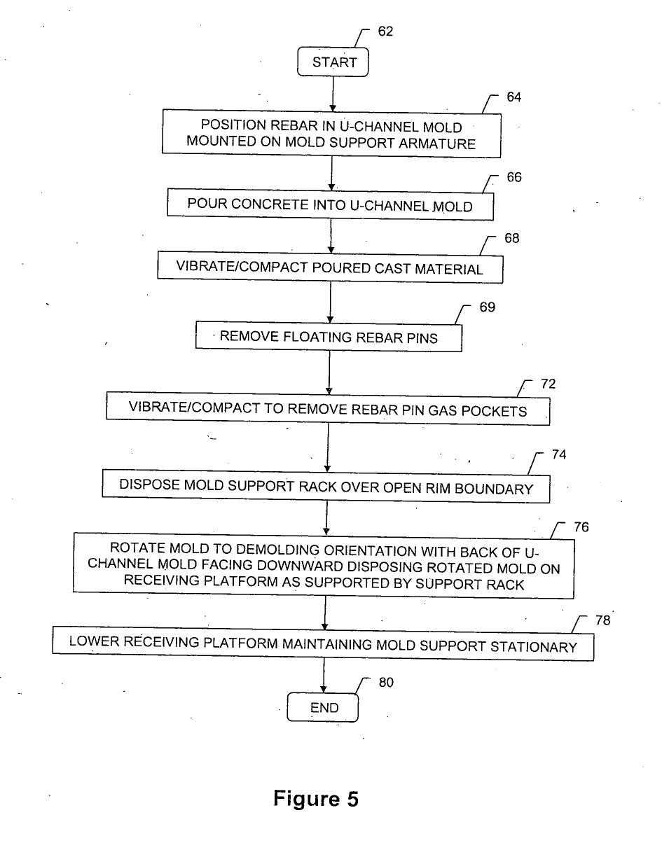

Referring now to FIGS. 2A and 2B, there are depicted perspective and cross-section views, respectively, of a casting mold apparatus in accordance with the present invention. As illustrated therein, casting mold 11 includes multiple aligned fastener holes 17 through which removable horizontal rebar retention pins 22 are inserted to provide a floating constraint for longitudinally disposed rebar members 24. The contour of casting mold 11 forms a pair of lobes 31 defined by the outer lateral sides of the mold and a longitudinal recess area 28. A substantially flat, elongated capping member 39 is affixed over the open mouth surface area defined by open rim boundary 25 during vibration treatment of the concrete casting material 15 as explained in further detail with reference to FIG. 5. Protruding downwardly from capping member 39 into the lobe areas 31 of the mold cavity are pairs of removable vertical retention pins 26 for securing rebar 24 in cooperation with horizontal removable pins 22 in the manner depicted in FIG. 2B.

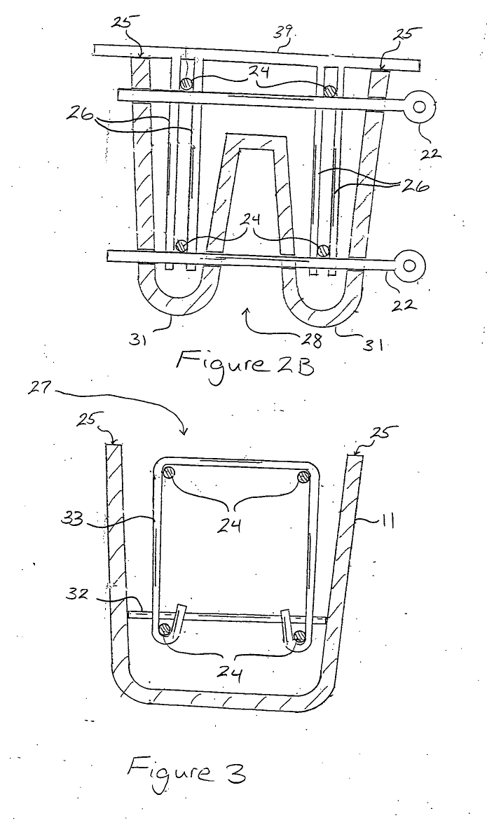

The predominant lengthwise U-channel cross-section contour of casting mold 11 illustrated in FIGS. 2A and 2B is interrupted at selected support joint positions by multiple transition shoulder areas 27 as shown in FIGS. 1B and 3. Referring to FIG. 3, there is depicted a cross-section view of a transition shoulder section of the cast mold apparatus. Unlike the U-channel cross-section areas defined by lobes 31 divided by lengthwise recess 28 as depicted in FIGS. 2A and 2B, the contour of the transition shoulder is rectangular, or preferably, slightly trapezoidal having no recessed area. Furthermore, the rebar 24 is securely retained within the transition shoulder during the molding process described hereinbelow by a spacer bar 33 in cooperation with a lodging pin 32.

Referring to FIGS. 4A and 4B in conjunction with FIG. 1A, there are illustrated front and cross-section views of cast member 18 as it is formed within casting mold 11 and slidably released therefrom in accordance with the present invention. As shown in FIG. 1A, cast member 18 is released with casting mold 11 in a horizontal demolding orientation that is approximately 180° rotated about the lengthwise axis from the horizontal molding orientation in which the concrete is poured into the mold with open rim boundary 25 facing upward. In the demolding orientation, while casting mold 11 is in the rotated demolding position 34, the lengthwise open rim boundary 25 is facing downward and the open mouth defined thereby is covered by an upper surface 9 of support rack 14, which is secured to casting mold 11 by mechanical fastening means such as hydraulic clamps following pouring and settling casting material 15 within the mold. Depending on the desired demolding sequence embodiment, receiving platform 6 is either raised or is pre-positioned by motor 8 to a level on vertical supports 12 such that when pivoting armature 2 is rotated to demolding position 34, the bottom surface of support rack 14 rests on and is supported by the top surface of receiving platform 6.

Once the weight of the mold/cast member combination is substantially supported by receiving platform 6, the hydraulic clamps or other mechanical fasteners (not depicted) used to attach support rack 14 to cast mold 11 are removed or otherwise released. In a preferred embodiment of the present invention, receiving platform 6 is then lowered such as by reversing motor 8 in a slow, controlled manner to allow cast member 18 to be gravity released in a slidable manner from the interior lining of casting mold 11 as supported by the upper surface of receiving platform 6.

As further depicted in FIG. 1A, the cast member 18 is released in the horizontal demolding orientation in which the substantially flat back surface 10 of cast member 18 is vertically supported by receiving platform 6 via support rack 14 in the depicted embodiment. FIG. 4A depicts an overhead view of cast member 18 without the support rack and illustrates various features such as multiple transition shoulder regions 38 supporting the lateral side lobes disposed across recessed areas 36 that define the characteristic U-channel cross-section contour of the cast member of the present invention. In order to facilitate the slidable gravity release from casting mold 11, the molded contour of cast member 18 is preferably tapered to narrow as is extends from the substantially flat backside 10 toward the lengthwise “front” side of cast member 18 depicted in FIG. 4A (as from right-to-left in the lengthwise cross-section shown in FIG. 4B).

This tapered contour having its widest edge at the back surface 10 is particularly advantageous when utilized with the molding/demolding method set forth herein. The shape imparted on cast member 18 by mold 11 enables cast member 18 to be released while the casting material is still in its uncured plastic phase. Specifically, the inwardly (from backside 10) tapering cross section contour of each of side walls 41 and transition shoulders 38 of cast member 18 result in a cast member center of gravity that is maximally shifted toward back side 10 thereby facilitating a gravity release in the depicted demolding orientation. This tapered contour further serves to provide maximum stability and support for the upwardly extending side walls 41 and transition shoulders 38 when cast member 18 has been released in the horizontal demolding orientation. For the foregoing reasons, and others that can be understood by those skilled in the art upon viewing the presently disclosed embodiments, the contouring of casting mold 11 facilitates and operates synergistically with the demolding process explained with reference to FIG. 5 to facilitate gravity release and subsequently provide sufficient resistance to downward creep of the uncured cast member as would otherwise occur using conventional concrete pole forms when an unsupported edge is gravity drawn downward and deformed while the mold is in the plastic phase.

With reference to FIG. 5, there is depicted a flow diagram illustrating process steps performed during casting of an elongated concrete pole in accordance with the present invention. The casting cycle process begins as shown at step 62 and proceeds to step 64 with rebar 24 disposed and anchored in lengthwise alignment with the mold cavity lobes 31 as constrained by rebar retention pins 22 and 26 in the floating manner depicted in FIGS. 2A and 2B. After positioning the rebar, and following a conventional concrete slurry mixing procedure, the concrete slurry is poured into the mold cavity as illustrated at step 66. As utilized herein, “concrete” refers to casting material suitable for constructing elongated pole structures such as low water content concrete mixtures. Next, and as depicted at step 68, the poured casting material is vibrated, using well-known air vibrators or the like, to remove trapped gases from the poured casting material.

After the gas pockets formed around crevices within the mold cavity such as around rebar members 24 have been substantially diminished or removed, vertical and horizontal rebar retention pins 26 and 22 are withdrawn from their respective embedded positions within casting mold 11 as depicted at step 69. After a final, typically brief vibration step for removing the pin removal gaps (step 72), and as illustrated at step 74 the support rack 14 is removably affixed over the open rim boundary of casting mold 11. Hydraulic clamps or other such removable mechanical-type fasteners may be utilized for capping the open rim boundary of casting mold 11 with support rack 14. It should be noted that steps 64 through 74 constitute a “molding phase” of a casting cycle during which armature 2 of concrete pole casting apparatus 5 is maintained in the position shown in FIGS. 1A and 1B with the open rim boundary 25 of mold 11 facing upward.

Proceeding as depicted at step 76, a “demolding phase” is commenced with casting mold 11 being rotated approximately 180° about lengthwise axis 23. In the depicted embodiment, this rotation is achieved by pivoting armatures 2 from the molding position to a demolding position 34 as shown in FIG. 1A. It should be noted that although the rotation of the casting mold as depicted in the present embodiments is accomplished by an arc-like rotation of an armature on which the mold is affixed and which includes both linear displacement as well as rotation of the mold, the present invention is not intended to be so limited. For example, the rotation of casting mold 11 about its lengthwise axis 23 may alternatively be accomplished using other electromechanical means that directly rotate mold 11 about axis 23 prior to or without the need for such linear displacement. In the demolding position, casting mold 11 is oriented such that the rim boundary 25 is facing downward and the concrete casting material is supported by support rack 14. The mold rotation step is preferably performed immediately following the aforementioned vibration and capping procedure prior to the casting material 15 curing.

Step 76 further includes the process steps and subsets required to position the mold and support rack combination such that the flat backside of the cast member 18 is supported by receiving platform 6. In one embodiment, the relative positioning between the mold and receiving platform 6 is achieved by raising platform 6 until the upper platform surface contacts the bottom surface of support rack 14 following rotation of armatures 2 to demolding position 34. In an alternate embodiment, receiving platform 6 is pre-positioned such that upon rotation of armatures 2 to demolding position 34, the bottom of support rack 14 is resting in abutment with the upper surface of the receiving platform.

Following the rotation of mold 11 via pivoting armatures 2, and in a beneficial feature of the casting process illustrated at step 78, receiving platform 6 is lowered by controlled actuation of motor 8 such that the casting material 15 is gravity-drawn from mold 11 as a cast member 18 onto the upper surface of the receiving platform while armatures 2 are maintained substantially stationary. Following the demolding phase comprising steps 76 and 78, the casting cycle terminates as shown at step 80 at which point mold support armatures 2 are free to re-position mold 11 back to the molding position in preparation for the next cycle. In a preferred embodiment, a dry mix type of concrete is utilized due to its relatively low uncured flow characteristics.

While this invention has been described in terms of several embodiments, it is contemplated that alterations, permutations, and equivalents thereof will become apparent to one of ordinary skill in the art upon reading this specification in view of the drawings supplied herewith. It is therefore intended that the invention and any claims related thereto include all such alterations, permutations, and equivalents that are encompassed by the spirit and scope of this invention.

1. A method for casting an elongated pole member comprising:
providing an elongated casting mold having a lengthwise rim boundary defining a planar open mouth from which a cast pole member can be slidably removed;
positioning the elongated casting mold in a horizontal molding orientation;
pouring casting material into the casting mold; and
rotating the mold to a demolding horizontal orientation in which the open rim boundary of the mold is facing downward.

2. The method of claim 1, wherein said rotating the mold comprises rotating the mold approximately 180° about its lengthwise axis.

3. The method of claim 1, wherein the casting material comprises low water content concrete mix.

4. The method of claim 1, wherein said rotating the mold to a demolding orientation is performed prior to the casting material curing.

5. The method of claim 1, wherein said rotating the mold to a demolding orientation is preceded by capping the open rim boundary with a support rack member.

6. The method of claim 1, wherein said rotating the mold to a demolding orientation is followed by positioning the mold relative to a receiving platform such that the casting material is supported at the open rim boundary of the mold by the receiving platform.

7. The method of claim 6, said positioning comprising raising the receiving platform such that the casting material is supported at the open rim boundary of the mold by the receiving platform.

8. The method of claim 6, wherein the mold is fixedly attached to a mold support member.

9. The method of claim 8, wherein said mold support member is a pivoting armature.

10. The method of claim 8, wherein said positioning the mold is followed by lowering the receiving platform such that the casting material is gravity-drawn from the mold onto the upper surface of the receiving platform while the mold support member is maintained substantially stationary.

11. The method of claim 8, wherein said positioning comprising lowering said mold support member such that the casting material is supported at the open rim boundary of the receiving platform.

12. A concrete pole casting apparatus comprising:
a mold support armature rotatably cycled between a molding position and a demolding position;
an elongated casting mold fixedly attached in a horizontal disposition to the mold support armature, wherein the elongated casting mold has a longitudinally disposed single plane open rim boundary facing upward when the mold support armature is in the molding position and facing downward when the mold support armature is in the demolding position; and
a receiving platform disposed in substantial vertical alignment with the mold support armature in the demolding position, said receiving platform vertically adjustable such that said receiving platform may be lowered such that the concrete cast within the casting mold is gravity-drawn from the mold onto the receiving platform.

13. The concrete pole casting apparatus of claim 12, further comprising a support rack affixed to the open rim boundary prior to the mold support armature being rotated to the demolding position.

14. The concrete pole casting apparatus of claim 12, wherein said mold support armature comprises a lever-like member having a first surface onto which said casting mold is attached.

15. The concrete pole casting apparatus of claim 12, further comprising electromechanical control means for cycling said mold support armature between the molding position and the demolding position.

16. The concrete pole casting apparatus of claim 15, wherein said electromechanical control means for cycling said mold support armature between the molding position and the demolding position includes motor means for rotating the mold support armature by approximately 180° between cycles.

17. The concrete pole casting apparatus of claim 12, wherein said casting mold comprises a substantially rigid mold liner contoured to produce a U-shaped cast member.

18. The concrete pole casting apparatus of claim 17, wherein said mold liner has a cross-section profile characterized as including a pair of side lobes separated by a recessed region.

19. The concrete pole casting apparatus of claim 17, wherein the casting mold has opposing inner lateral sides that taper inwardly from one end of the mold to the other.
